(19) United States
(12) Patent Application Publication
(10) Pub. No.: US 2009/0058077 A1
(43) Pub. Date: Mar. 5, 2009

(54) Multicoupling Device

(76) Inventors: Winfried Schulz, Neuhausen (DE); Hans-Jurgen Claus, Stuttgart (DE); Klaus Zoller, Stuttgart (DE); Viola Amiridis, Esslingen (DE); Hans-Walter Brenner, Stuttgart (DE); Martin Weiss, Goppingen (DE); Andreas Rau, Ostfildern (DE); Monika Scherer, Schallstadt/Mengen (DE)

Correspondence Address: Steven T Zuschlag;Hoffmann & Baron, 6900 Jericho Turnpike, Syosset, NY, 11791, US

(21) Appl. No.: 12/224,736

(22) PCT Filed: Feb. 1, 2007
(86) PCT No.: PCT/EP2007/000855

§ 371 Date: Sep. 19, 2008

(30) Foreign Application Priority Data
Mar. 6, 2006 (DE) 102006010165.0

(51) Int. Cl. F16L 35/00

(52) U.S. Cl. 285/81

(57) ABSTRACT

A multiple coupling means for the production of a releasable connection between fluid lines for a fluid pressure medium and associated with a fluid pressure source, said lines being on the source side and fluid lines associated with at least one fluid load and placed on the load side, said coupling means comprises a first coupling part (12) having several first fluid ports (13) and a second coupling part (14) possessing several second fluid ports (15) for the fluid lines on the load side, the two coupling parts (12 and 14) being able to be shifted in a coupling operation into a working position (22) by being moved together in the direction of an installation axis (21), in which working position (22) mutually opposite joint faces (17 and 19) of the two coupling parts (12 and 14) engage each other and in which the two coupling parts (12 and 14) are secured by means of holding means to avoid accidental uncoupling, an actuating means (23) able to be operated manually is provided, by means of which the coupling parts (12 and 14) are able to be shifted from a ready for use position (24), in which the coupling parts (12 and 14) are releasably in contact with each other and the joint faces (17 and 19) are spaced apart, using force transmission means (35 and 50) into the working position.

The invention relates to a multiple coupling means for the production of a releasable connection between fluid lines for a fluid pressure medium and associated with a fluid pressure source, said lines being on the source side and fluid lines associated with at least one fluid load and placed on the load side, said coupling means comprising a first coupling part having several first fluid ports for the fluid lines on the source side and a second coupling part possessing several second fluid ports for the fluid lines on the load side, the two coupling parts being able to be shifted in a coupling position into a working position by being moved together in the direction of an installation axis, in which working position mutually opposite joint faces engage each other and in which the two coupling parts are secured by means of holding means to avoid accidental uncoupling.

Such a multiple coupling means is disclosed in the German patent publication DE 1 923 186, where a first coupling part on the source side resembles an electrical multiple pole jack, which is able to be plugged onto a second coupling part on the load side in the form of a corresponding socket. In order to prevent accidental release or respectively uncoupling of the two coupling parts from each other it is possible to provide, on an outer side of the first coupling part, a strip spring with an inwardly bent spur, which for coupling snaps into recess provided for this purpose in the second coupling part.

The coupling up of fluid lines under pressure using a coupling means requires a substantial amount of force, since it is necessary to operate against the fluid pressure. In the case of a multiple or multi-pole coupling the force required is multiplied in accordance with the number of connected fluid lines. For example in the case of the prior art devices mentioned above it is necessary to plug on the plug-like first coupling part against the check valves, which are held in the closed position by the acting fluid pressure and spring force. A coupling operation performed by hand is therefore only impeded or even not possible at all owing to the substantial effort required in the case of such multiple coupling means.

One aim of the invention is to provide a multiple coupling means of the type initially mentioned in the case of which the coupling operation is able to be implemented with a relatively small amount of force by hand.

This object is to be achieved by a multiple coupling means with the features of the independent claim 1. Further developments of the invention are indicated in the dependent claims.

The multiple coupling means of the invention is characterized in that an actuating means able to be operated manually is provided, by means of which the coupling parts are able to be shifted from a ready for use position, in which the coupling parts are releasably in contact with each other and the joint faces are spaced apart, using force transmission means into the working position.

The coupling operation is accordingly aided by force transmission means so that the coupling operation may be performed manually without substantial effort. As a rule the direction of flow of the fluid flowing through the coupling means will be in parallelism to the installation axis of the two coupling parts so that coupling operation, in which the coupling parts are shifted toward each other in the direction of the installation axis, is hindered by the fluid pressure. The opposite pressure in the uncoupling direction, which is undesired, may occur at the first coupling part on the source side, for example when the source of pressure is not turned off and pressure medium flows out. It is possible as well for the counter pressure to obtain at the second coupling part on the load side, which is preferably provided with at least one closure member and in particular a check valve. The check closure member may during uncoupling automatically close so that fluid pressure possibly still required at the load is maintained. On coupling the check closure member may more particularly be opened by means of a union member provided on the first coupling part corresponding to it in order to provide a fluid passage right through the coupling means. In this case the check closure member is however maintained in its closed position by spring force and by means of fluid pressure on the load side so that a relatively large force must be applied for opening. In the case of several check closure members the force to be applied is even greater. Via the actuating means and its force transmission means a relatively simple opening of such check closure members is rendered possible so that the force of the hand applied to the actuating means is sufficient.

The term fluid pressure medium is employed within the meaning of the invention as more particularly denoting compressed air. Nevertheless other gaseous or also hydraulic pressure mediums may be used.

The coupling and uncoupling of fluid lines under pressure are tasks, repeatedly performed every day. In the case of carelessly performed uncoupling the whipping movements of fluid lines, more particularly compressed air hose, often causes damage and or even injury. In order to cope with this problem a captive position may be provided between the ready for use position and the working position of the two coupling parts, in which the mutually opposite joint faces are spaced from each other and the coupling parts are connected undetachably. In this position it is admittedly possible for air to be let off, the pressure forces occurring in the uncoupling direction however do not entail the two coupling parts being disconnected from each other and in fact in the captive position they are still mechanically joined together.

In a more particularly preferred manner the force transmission means may include at least one guide track, on which the at least one guide element is positively guided on use of the actuating means, the guide track having such a form that the coupling parts during coupling are shifted toward each other and during uncoupling are shifted apart. The course of the guide track sets the force transmission ratio between the manual force applied to the actuating means and the coupling forces transmitted from the actuating means to the two coupling parts in the direction of the installation axis. Accordingly coupling means may be employed having different guide track forms in order to so adapt to different pressure relationships.

The guide track possesses in all at least three different sections in which in each case different functions may be performed. The guide track may have a coupling/uncoupling section associated with the ready for use position of the coupling parts, in which the at least one guide element may be brought into contact with the associated guide track for a coupling operation and brought out of contact with it for an uncoupling operation. Furthermore the guide track may possess a holding section in the working position of the coupling parts, in which the guide element secures the two coupling parts to prevent accidental uncoupling. Finally it is possible for an uphill section to be provided, in which the guide element is shifted between the coupling/uncoupling section and the holding section.

It is possible to provide a further functional section on the guide track, namely a securing section between the coupling/uncoupling section and the holding section, which is associated with the captive position of the two coupling parts. In this securing section the guide element may be so positioned that the two coupling parts are secured against uncoupling when the joint faces are spaced apart. For example it is possible for the guide element to snap into a latching notch in the securing section.

The guide track may be formed on the second coupling part on the source side and the guide element corresponding to it may be formed on the actuating means. As an alternative to this it is possible for the guide track to be provided on the actuating means and for the guide element corresponding to it to be provided on the first coupling part on the source side. On operation of the actuating means the first coupling part may be shifted in relation to the more particularly stationarily arranged second coupling part, for example for coupling to the second coupling part or for uncoupling shifted farther away.

In the case of a further development of the invention the guide track is formed in a groove-like guide slide provided on the first coupling part or on the actuating means, and preferably a groove, in particular on one of the groove's flanks.

It is possible for the actuating means to be so designed that in a linear movement it may be shifted athwart the installation axis between a coupling/uncoupling position associated with the ready for use position of the two coupling parts and a latched position associated with the working position of the two coupling parts. The force for the coupling and, respectively, uncoupling operation may therefore be transmitted in a linear movement of the actuating means.

In the alternative the actuating means may be so designed that it is shifted by a rotary movement with the installation axis as an axis of rotation between a coupling/uncoupling position associated the ready for use position of the two coupling parts and a latched position associated with a latched position associated with the working position of the two coupling parts. The force for coupling and, respectively, uncoupling may therefore be transmitted by means of a rotary or turning movement of the actuating means.

In the case of a further alternative the actuating means can be so designed that it is able to be pivoted in a swinging movement about a pivot axis essentially normal to the installation axis between a coupling/uncoupling position, associated with the two coupling parts and a latched position associated with the working position of the two coupling parts.

The force for coupling and, respectively, uncoupling may here be applied in a pivoting movement of the actuating means.

Preferred working embodiments of the invention are illustrated in drawings and will be described in the ensuing account.

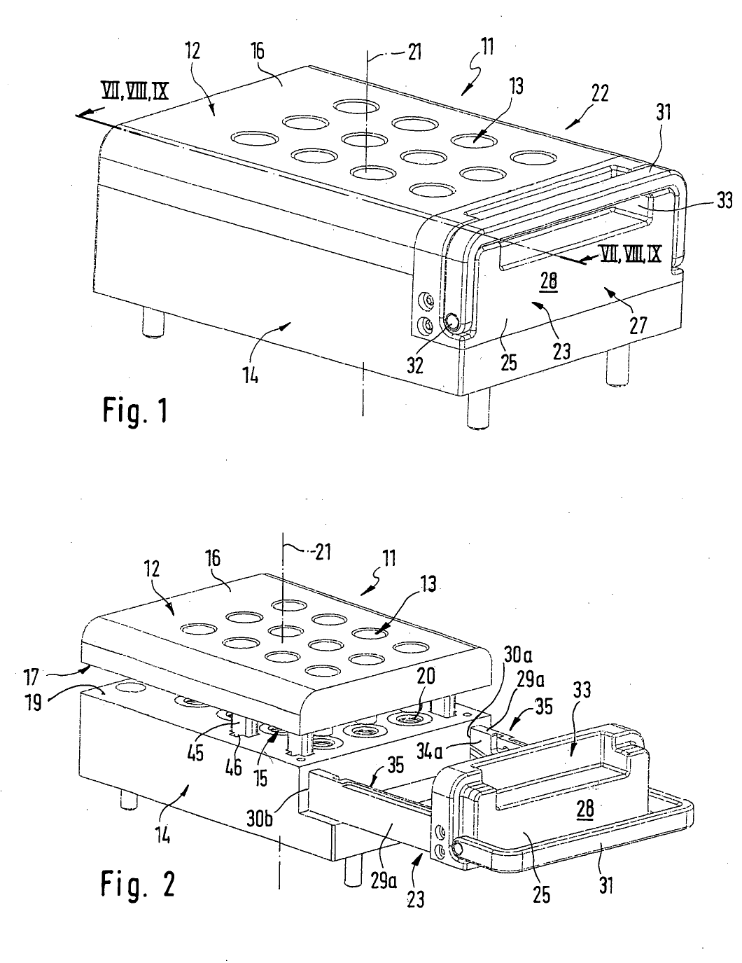

FIG. 1 is a perspective elevation of a first working example of the coupling means in accordance with the invention.

FIG. 2 shows a perspective view of the coupling means of FIG. 1, the joint faces of the two coupling parts being spaced apart.

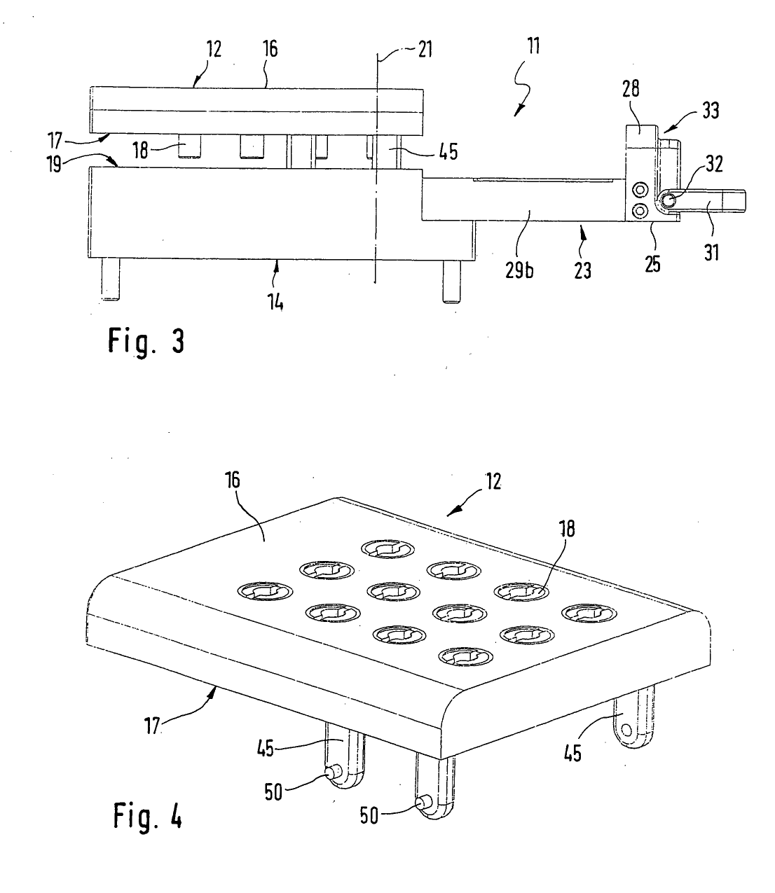

FIG. 3 is a lateral view of the coupling means according to FIG. 2.

FIG. 4 is a perspective elevation of the first coupling part, on the source side, of the coupling means in accordance with FIG. 1.

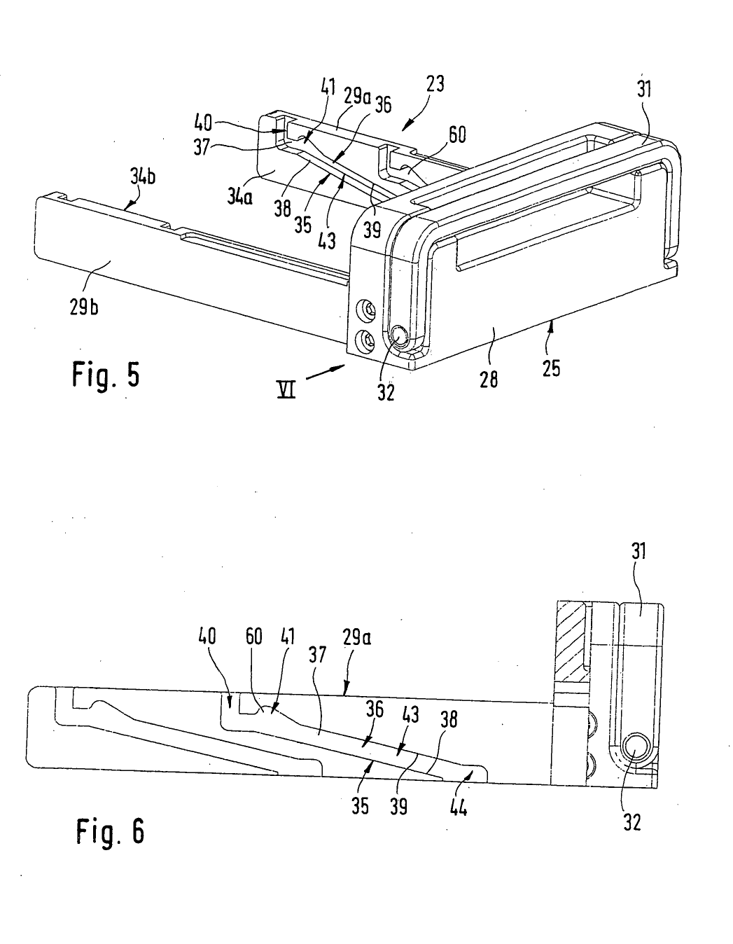

FIG. 5 is a perspective showing of a part of the actuating means of the coupling means in accordance with FIG. 1.

FIG. 6 shows a lateral view of the actuating means of FIG. 5 in the arrowed direction VI, the limb of the actuating means which is to the fore in the arrowed direction being cut away.

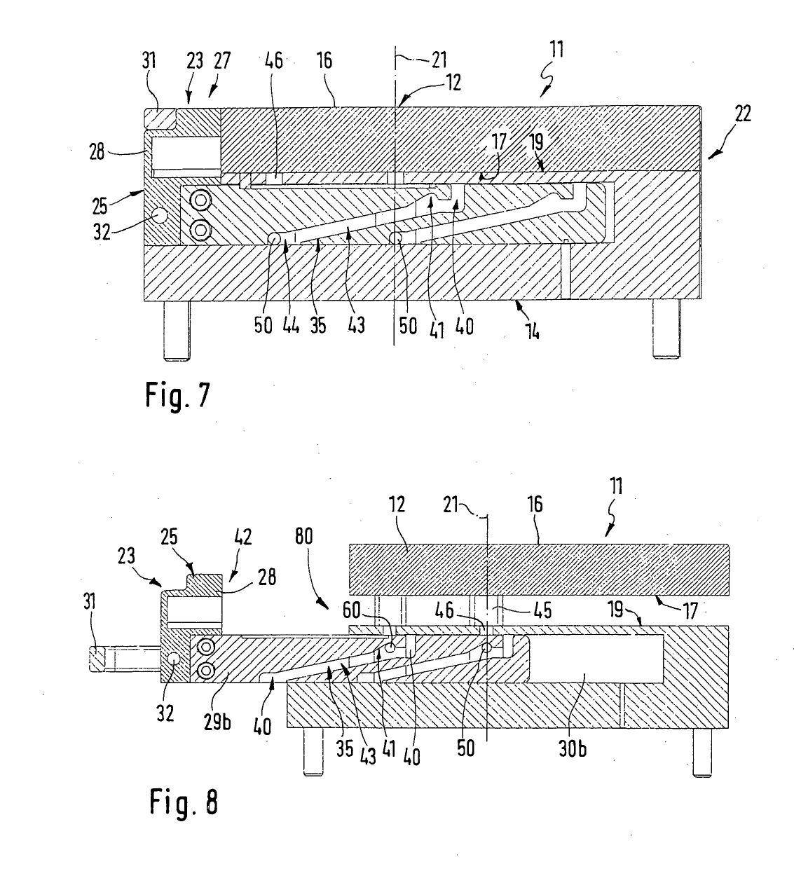

FIG. 7 shows a longitudinal section taken through the coupling means of FIG. 1 on the section line VII-VII in FIG. 1, the two coupling parts being in the working position and the actuating means being in the latched position.

FIG. 8 is a longitudinal section taken through the coupling means on the line VIII-VIII of FIG. 1, the two coupling parts being in the captive position and the actuating means being in the securing position.

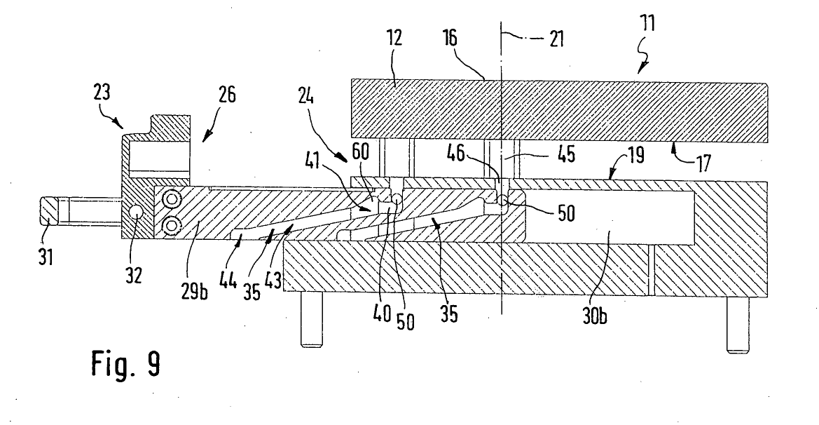

FIG. 9 is a longitudinal section through the coupling means of FIG. 1 along the line IX-IX in FIG. 1, the two coupling parts being in the ready for use position and the actuating means being in the coupling/uncoupling position.

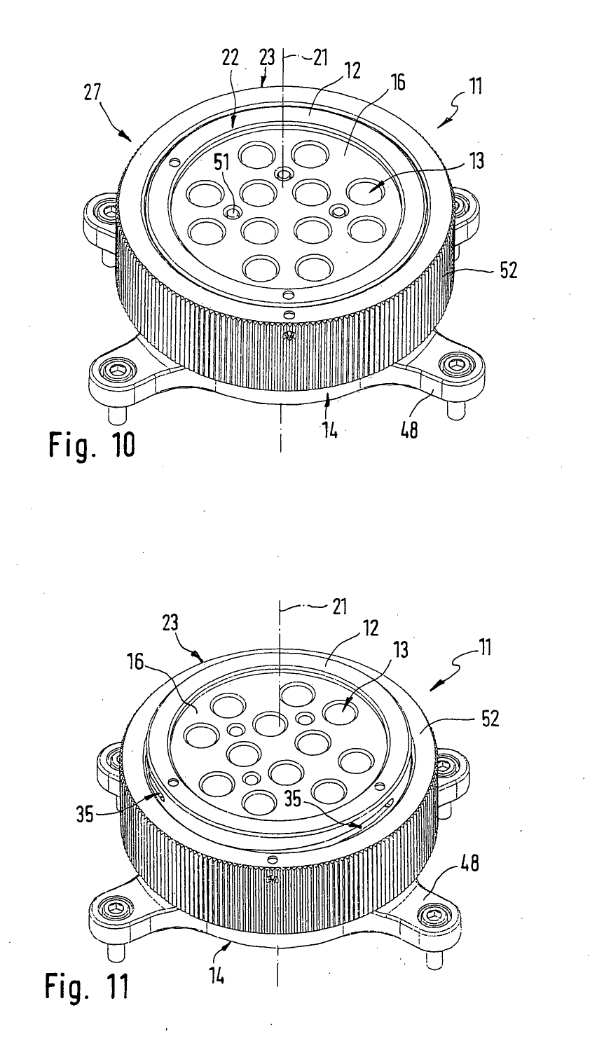

FIG. 10 is a perspective representation of a second working example of the coupling means of the invention.

FIG. 11 shows a perspective view of the coupling means of FIG. 10, the joint faces of the two coupling parts being spaced from each other.

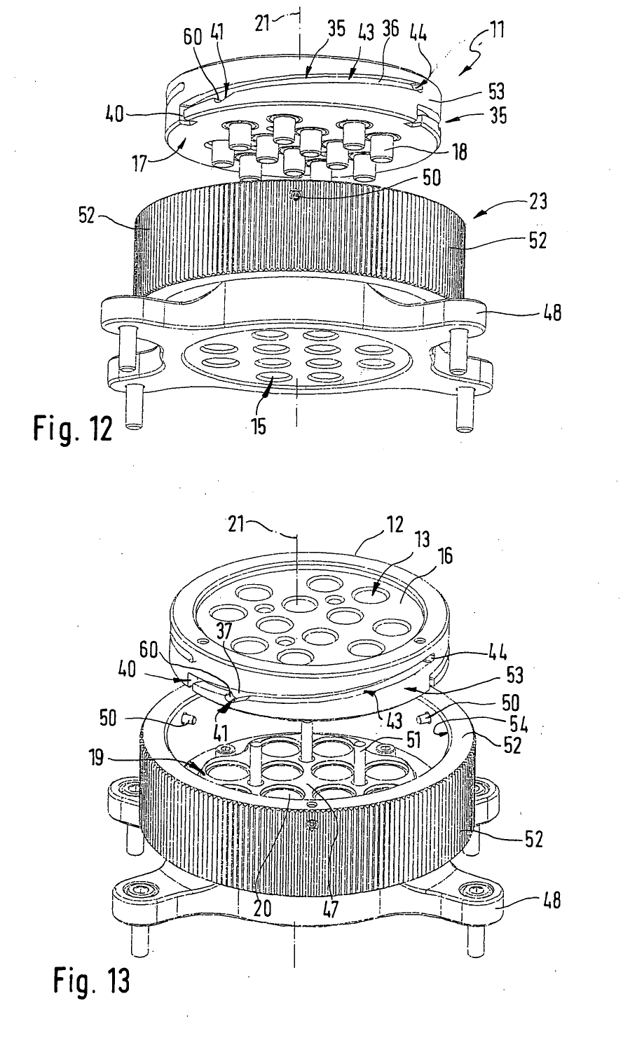

FIGS. 12 and 13 are perspective views of the coupling means of FIG. 10, the two coupling parts being illustrated separated from each other.

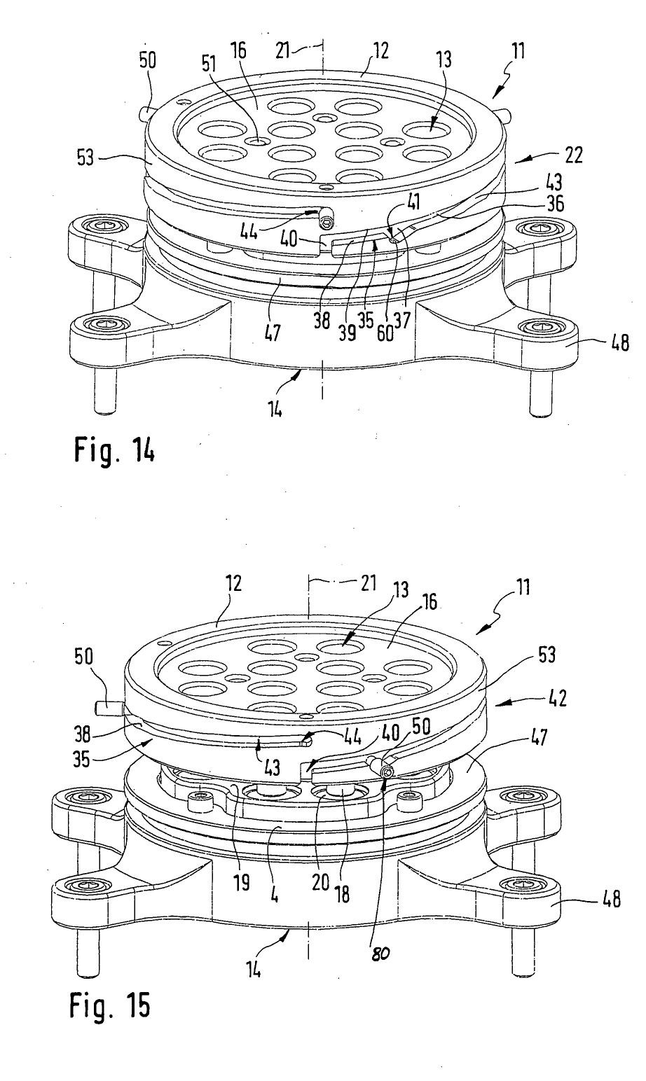

FIG. 14 is a perspective view of the coupling means of FIG. 10, wherein for the sake of clarity only the guide means provided on the actuating means being represented, the two coupling parts being in the operating position.

FIG. 15 is a perspective representation of the coupling means according to FIG. 10, the two coupling parts being represented in the captive position.

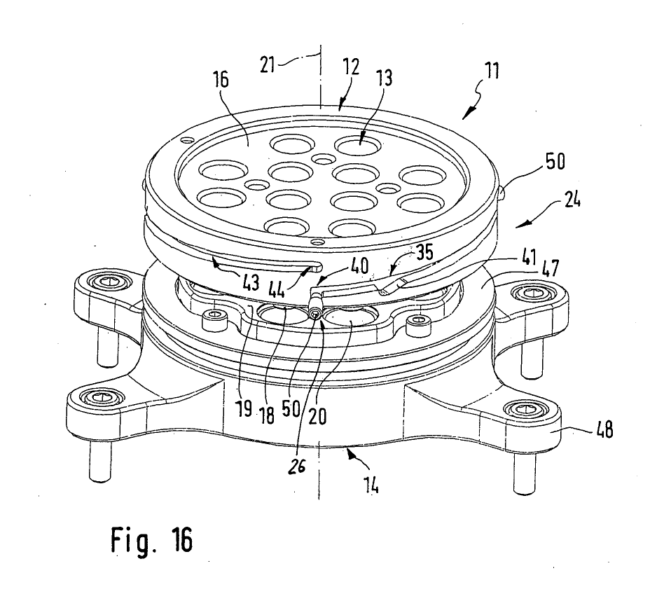

FIG. 16 is a perspective representation of the coupling means in accordance with FIG. 10, the two coupling parts being shown in the ready for use position.

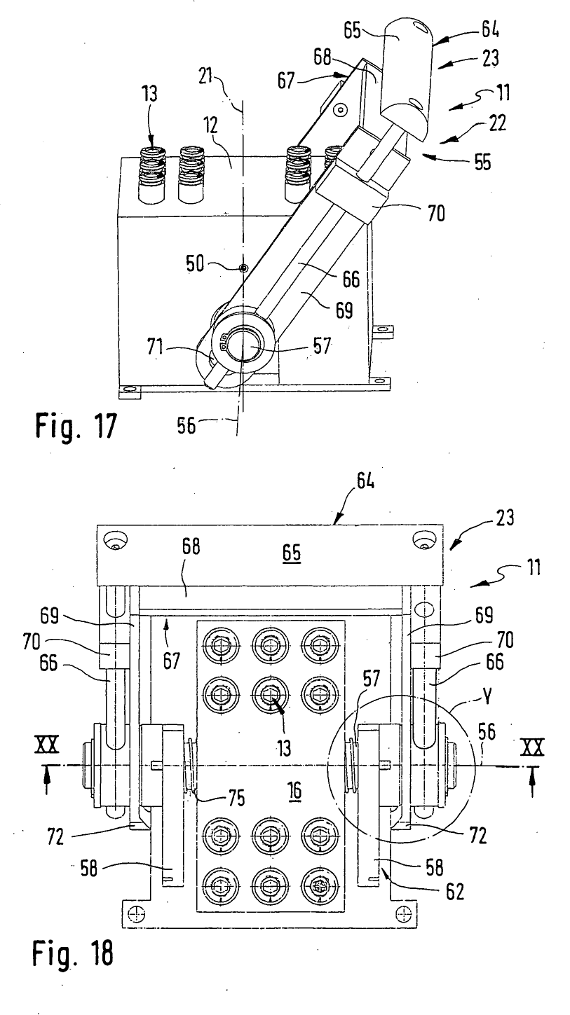

FIG. 17 is a perspective view of a third embodiment of the invention as a coupling means.

FIG. 18 is a view from above of the coupling means of FIG. 17.

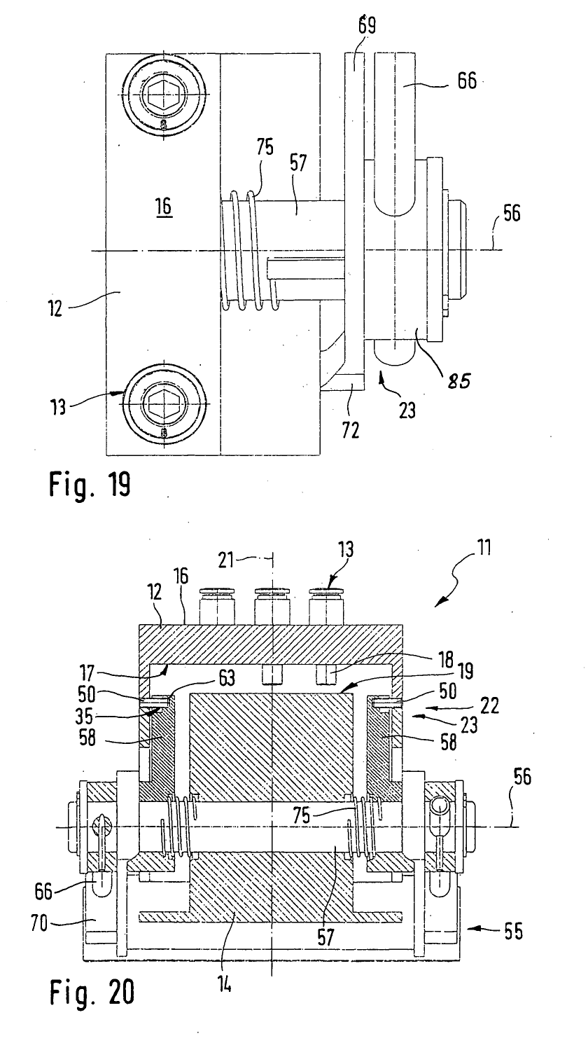

FIG. 19 shows the detail y in FIG. 18 on a larger scale without the setting disk.

FIG. 20 represents a section taken through the coupling means of FIG. 17 according to the section line XX-XX in FIG. 17.

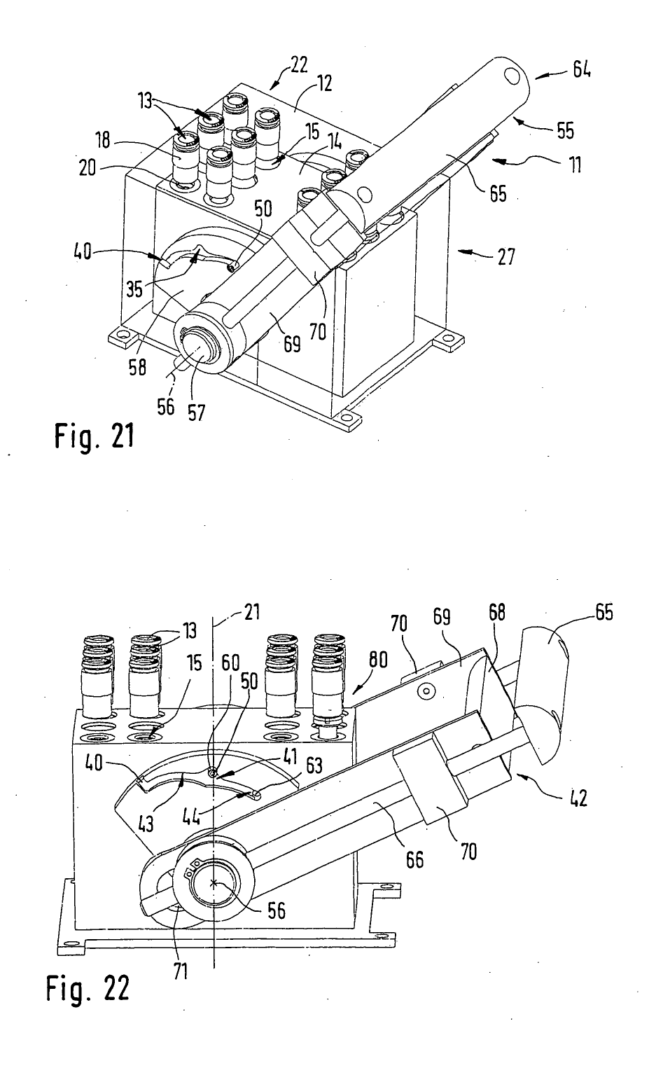

FIG. 21 is a perspective representation of the coupling means of FIG. 17, in which for the sake of clarity the first coupling part on the source side is illustrated in phantom and the two coupling parts being in their working positions and the actuating means being in the latched position.

FIG. 22 is a perspective elevation of the coupling means of FIG. 17 without the first coupling part, the actuating means being located in the securing position.

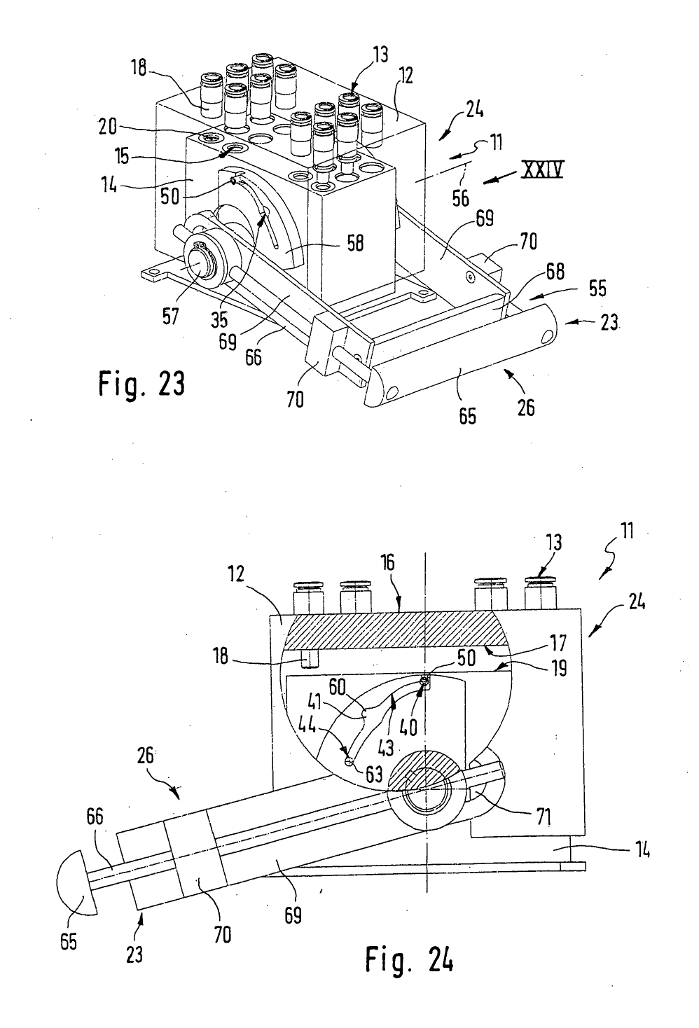

FIG. 23 is a perspective showing of the coupling means of FIG. 17, the first coupling part being illustrated in phantom and the two coupling parts being in the ready for use position, while the actuating means is in the coupling/uncoupling position.

FIG. 24 is a lateral view of the coupling means of FIG. 23 looking in the arrow direction XXIV as in FIG. 23, a part of the coupling means being illustrated cut away.

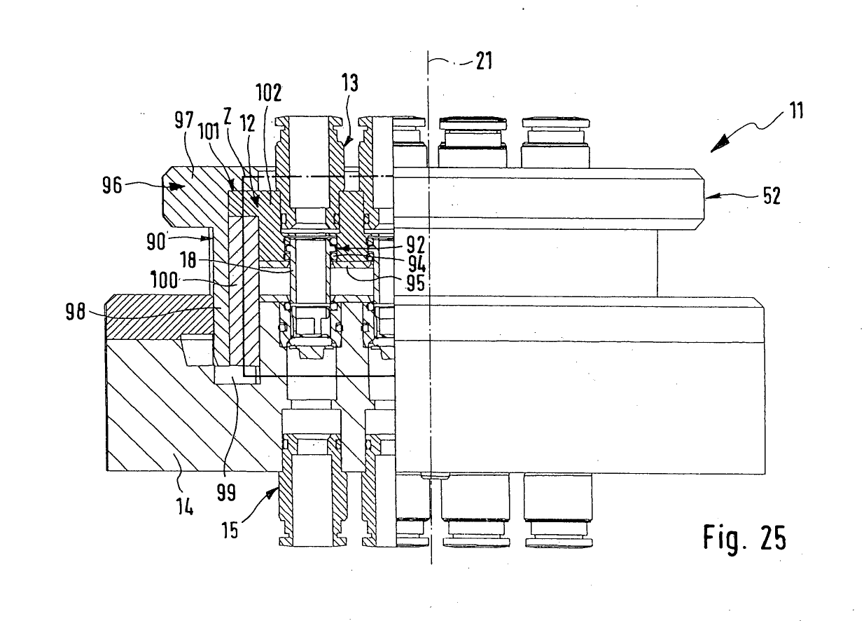

FIG. 25 is a lateral view or, respectively, a partial view of a further modification of the second coupling means embodying the invention.

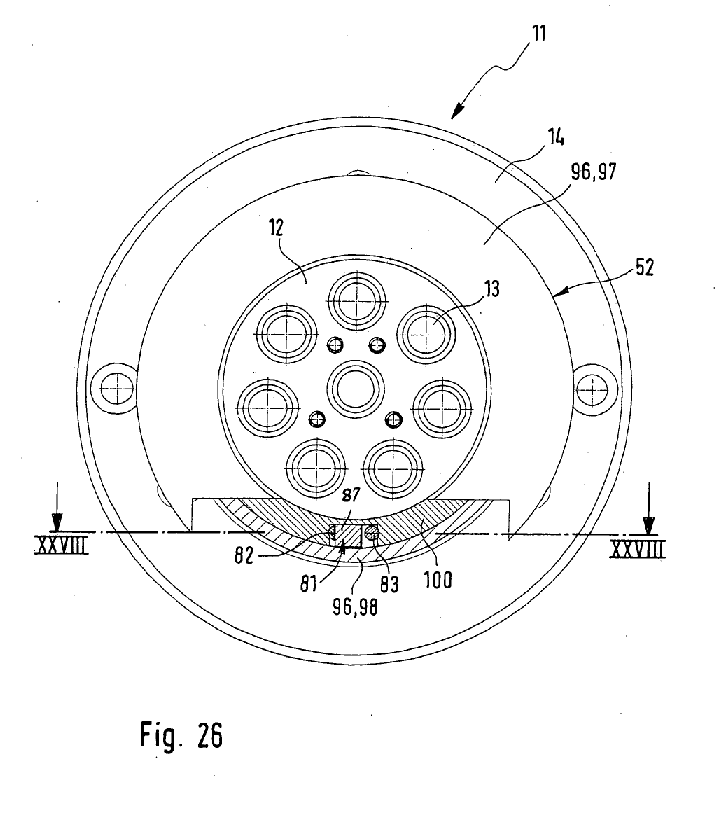

FIG. 26 is a view from above and partial section of the coupling means of FIG. 25.

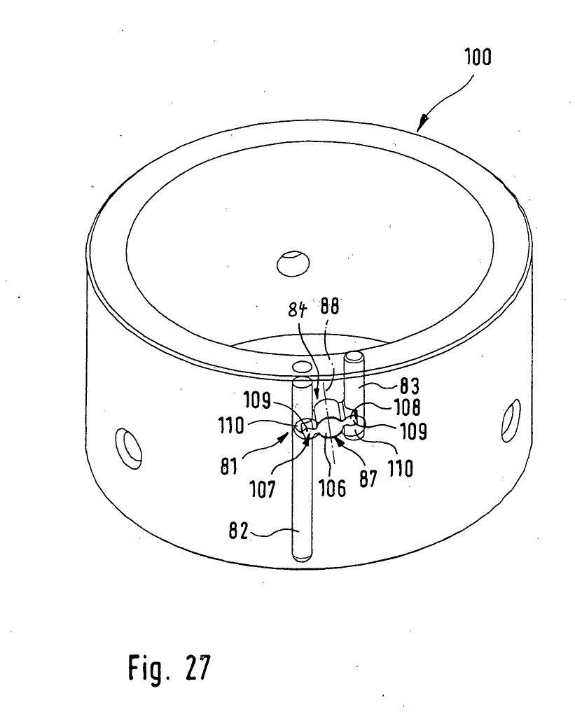

FIG. 27 shows the inner ring of the setting ring as in FIG. 25 in a separate perspective representation.

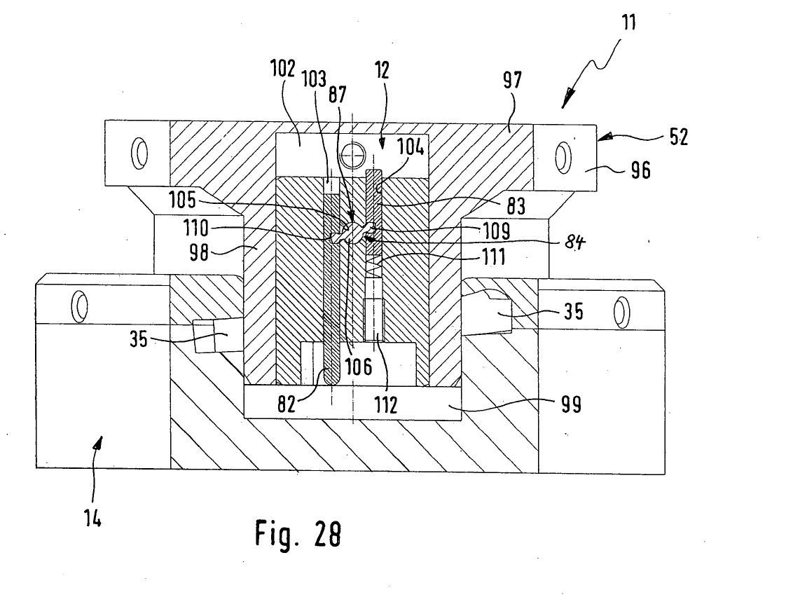

FIG. 28 is a section taken through the coupling means of FIG. 26 along the line XXVIII-XXVIII.

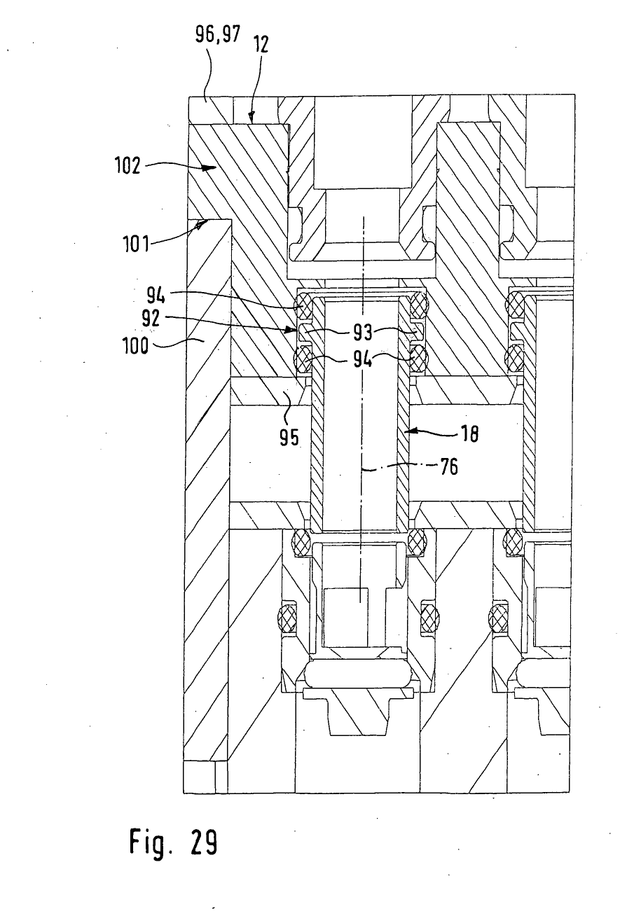

FIG. 29 shows an enlarged view of the detail Z in FIG. 25.

FIGS. 1 through 9 show a first working example of the multiple coupling means 11, which could also be termed a multiple pole coupling. For the sake of simplicity the multiple coupling means will in the following be termed a coupling means 11. Such coupling means 11 serve for the production of a releasable connection between fluid lines (not illustrated) associated with a fluid pressure source or producer and fluid lines (not illustrated) associated with at least one fluid load. As a fluid pressure medium it is a question more particularly of compressed air. The fluid source is for example an air compressor.

The coupling means possesses a first coupling part 12 on the source side—in the following referred to as the first coupling part 12—which has several fluid ports 13 for the connection of the fluid lines on the source side. Moreover, there is a second coupling part 14 on the load side—in the following named the second coupling part 14—which possesses several second fluid ports for the connection of the fluid lines on the load side.

The first working example of the novel coupling means 11 illustrated in FIGS. 1 through 9 by way of example possesses a first coupling part 12 with a plate-like configuration, which has several first fluid ports arranged on grid in the form of fluid ducts 13, more particularly of cylindrical shape. The fluid ducts 13 extend through the plate-like first coupling part 12 from its top face 16 to its bottom face 17. The bottom face in this respect constitutes the joint face 17, described in detail below, of the first coupling part 12. As more particularly illustrated in FIG. 4, union members in the form of union sleeves 18 are inserted into the fluid ducts 13, such sleeves projecting at the top for the connection of the above mentioned fluid lines on the load side and at the bottom project somewhat past the joint face 17. The union sleeves 18 are mounted in a floating manner for radial movement in relation to their respective longitudinal axis 78 in the fluid ducts 13 and 15. The floating arrangement of the union sleeves 18 may be adopted in the case of all three working embodiments described. The floating arrangement of the union sleeves 18 will be described in conjunction with the second working example of the coupling means 11 explicitly.

The second coupling part 14 also possesses a plate-like shape and in a fashion corresponding to the first coupling part 12 also has second fluid ports, also arranged on a grid, in the form of fluid ducts 15. On coupling up the two coupling parts 12 and 14 the fluid ducts 13 and 15 are so joined together in circuit that a fluid passage is formed through the coupling means 11.

The top side of the second coupling part 14 in this case constitutes the joint face 19, which is opposite to the joint face 17 of the first coupling part 12. Check closure members in the form of check valves are inserted in the fluid ducts 15 in the second coupling part 14 and such members being opened during the coupling operation owing to the mutual movement together of the union sleeves 18 downwardly projecting from the joint face 17 of the first coupling part 12.

During the coupling operation he two coupling parts 12 and 14 are transferred into a working position 22 in the movement together in the direction of an installation axis 21 and in such working position the mutually opposite joint faces 17 and 19 are secured together by means of holding means to prevent accidental uncoupling. The check valves 20 inserted in the fluid ducts 15 of the second coupling part 14 are held in their closed positions by spring force and by means of the fluid force obtaining. During the coupling operation a thrust must be applied against this closing force. This means that a substantial effort is required, which is often not able to be applied by hand alone. In order to provide for manual coupling an actuating means 23 is provided, with the aid of which the coupling parts 12 and 14 may be transferred from a ready for use position 24, in which the coupling parts 12 and 14 are releasably in contact with each other and the joint faces 17 and 19 are however spaced apart, with the use of force transmission means into the working position 22.

The actuating means 23 possesses in the first working example an actuating yoke 25, which is mounted in a sliding manner in the second coupling part 14 and accordingly in a linear movement athwart the installation axis may be shifted between a coupling/uncoupling section 26 associated with the ready for use position 24 of the two coupling parts 13 and 14 and a latched position 27 associated with the working position 22 of the two coupling parts 12 and 14. The actuating yoke 25 possesses a base section 28 and two limbs 29a and 29b projecting generally at a right angle from the base section 28, such limbs running in respectively associated guide sockets 30a and 30b in the second coupling part 14. The base section 28 possesses a handle 31 on its end remote from the limbs 29a and 29b, such handle being mounted in a pivoting fashion by pivoting means 32 on the base section 28 and is able to be pivot between a rest position and a position of use. In the first position the handle 31 engages the base section 28, whereas in the position of use it is pivoted away from the base section 28. In order to grip the handle more satisfactorily a socket 33 may be provided on the base section 28 into which the user's fingers may be put.

On the mutually opposite inner sides 34a and 34b of the two limbs 29a and 29b a part of the force transmission means is formed, namely respectively at least one guide track 35. On the guide track 35 at least one guide means in the form of a guide pin 50 is positively guided in a manner to be described below. As more particularly depicted in FIGS. 5 through 9 the guide track 35 is a component of a guide slide formed on the respective inner sides of the limbs in the form of a groove 36, which for its part has groove flanks 38 on either side of the groove floor 37, the top groove flank 38 serving as the guide track 35.

Each respective guide track 35 comprises a coupling/uncoupling section 40 associated with the ready for use position 24 of the coupling parts 12 and 14, against which section 40 the at least one guide means 50 is shifted out of contact for uncoupling or for coupling is shifted into contact with it at the associated guide track 35. On the coupling/uncoupling section 40 the respective groove 36 is open toward the narrow side of the associated limb 29a and 29b so that in this case the associated guide pin 50 may be “threaded in or out”. The coupling/uncoupling section furthermore has a relatively short horizontally extending portion, which is adjoined by a securing portion 41 of the guide track 35. On the securing portion 41a latching notch is 60 formed, into which an associated guide pin 50 may snap. The securing portion 41 of the guide track 35 corresponds to a securing position 42 of the actuating yoke. This securing position 42 for its part corresponds to a captive position 80 of the two coupling parts 12 and 14 so that on uncoupling orderly venting is possible without the coupling parts 12 and 14 beating violently pushed apart by the pressure obtaining, something which might result in the disadvantageous effects mentioned above. The securing portion 41 then merges into a uphill portion 43 formed as an inclined plane, which for its part merges with a holding portion 44 corresponding to the working position 22 of the two coupling parts 12 and 14. The holding portion 44 possesses an abutment for the guide pin 50, which in the present case is constituted by the tapering groove 36.

The other part of the force transmission means is located on the first coupling part 12, the first coupling part 12 having at least two downwardly protruding ribs 45 on its bottom side or joint face 17, which each have a guide pin 50, like a hook catch on their end facing away from the joint face 17. The guide pins 50 end extend essentially perpendicularly from the outer sides, which are turned away from the each other, of the ribs 45. In order to prevent skew positioning of the two coupling parts 12 and 14 during coupling or, respectively, uncoupling on the inner sides 34a and 34b of the limbs 29a and 29b it is possible to provide in each case two guide tracks 35 arranged in tandem, two ribs 45, arranged in tandem on the bottom side of the first coupling part 12 being provided in a corresponding manner. In principle it would however be possible to provide respectively one pair of ribs 45 and one pair of guide tracks 35. The ribs 45 could respectively fit into openings 46, whose cross section is adapted to the rib cross section, in the second coupling part 14, the openings 46 opening into the guide sockets 30a and 30b so that the guide pins 50 may, in a suitable position of the actuating yoke 25, be introduced into the respectively associated guide track 35 and respectively withdrawn from it.

During the coupling operation in the first working example depicted in FIGS. 1 through 9 of the coupling means 11 firstly the actuating yoke 32 is so shifted that the openings 46 in the second coupling part 14 are in line with the coupling/uncoupling section 40 on the guide tracks 35. The ribs 45 on the bottom side of the first coupling part 12 may then fit through the openings 46 and the coupling/uncoupling section 40 into the respectively associated guide tracks 35. The two coupling parts 12 and 14 are now located in their ready for use position 24, whereas the actuating yoke 25 is in its coupling/uncoupling position 26. The two mutually opposite joint faces 17 and 19 are still spaced apart in this position. Next the actuating yoke 25 is thrust inward toward the second coupling part 14, the guide pins 50 sliding along the guide tracks so that the two coupling parts 12 and 14 are forced to move together. The yoke 25 is now thrust still farther toward the second coupling parts 14 so that it goes along over the securing portion 4 and the guide pins 50 finally run over the rising portion 43 into the holding portion 44. Here the guide pins 50 abut the tapering end walls (which run athwart the respective guide track 35) of the grooves 36 so that the latched position 27 of the actuating yoke 25 is set. During the movement of the two joint faces 17 and 19 toward each other, which necessarily occurs on insertion of the actuating yoke 25, the connection sleeves 18 thrust the associated check valves 20 into their open position so that a fluid passage is opened. If the actuating yoke 25 is in its latched position 27 the two joint faces 17 and 19 will abut each other, i.e. the two coupling parts 12 and 14 are located in their working position 22 and fluid pressure medium, more particularly compressed air may go from the fluid lines on the source side via the coupling means 11 to the fluid lines on the load side.

The uncoupling operation is pictured in the FIGS. 7 through 9. In this case the actuating yoke 25 ia located in its latched position 27, as depicted in FIG. 7, thrust inward toward the second coupling part 14. The handle 31 on the base portion 28 of the actuating yoke 25 is now pivoted outwardly so that the latter may be pulled out of the guide sockets 30a and 30b in the second coupling part 14. Then the guide pins 50 are shifted from the holding portion 44 via the uphill portion 43 into the securing portion 41. The securing portion 44 corresponds to a captive position 80 of the two coupling parts 12 and 14 and ensures that the second coupling parts 12 and 14 may be vented without any difficulty or danger. The two joint faces 17 and 19 are therefore in contact with each other, but the two coupling parts 12 and 14 are despite this mechanically coupled. If the actuating yoke 25 is pulled back still farther outward, the guide pins 50 will enter the coupling/uncoupling section 40, whence they can be “unthreaded” by way of the opening 46 so that the two coupling parts 12 an may be separated from one another.

In FIGS. 10 through 16 or, respectively, 24 through 29 a second working embodiment of the coupling means 11 in accordance with the invention is represented. The coupling means 11 possesses a circular disk-like first coupling part 12, on which in a manner like in the first working embodiment first fluid ports in the form of fluid ducts 13 in a grid pattern are provided. In the fluid ducts 13 there are union sleeves 18 (FIGS. 15, 25 and 29). The coupling means 11 consists of several components, namely the first coupling part 12, the second coupling part 14 and for example according to the second working example a setting ring 52, which is produced with a certain specific component tolerance. Both in the first coupling part 12 and also in the second coupling part 14 there are several fluid ducts 13 and 15, of which each fluid duct 13 in the first coupling part 12 has exactly one corresponding partner in the second coupling part 14. It is accordingly necessary to align the fluid ducts 13 inside the first coupling part 12 correctly with their partners in the second coupling part 14. If the connection sleeves 18 were rigidly located in the associated fluid ducts there might be a chance, due tolerances, of one or more connection sleeves 18 not fitting into the associated fluid ducts 15 in the second coupling part 14. In order to avoid such tolerance-dependent difficulties during connection of the parts, the floating support looking in the direction as indicated by the arrow of the connection sleeves 18 in the fluid ducts 13 and 15 is provided. One respective connection sleeves 18 may therefore align itself in a radial direction in relation to it respective longitudinal axis 76 so that even in the case of the fluid ducts not being quite in alignment in the first or, respectively, second coupling part 12 and 14 a connection is nevertheless possible. As more particularly indicated in FIG. 29 each respective connection sleeve 18 possesses a bearing portion 92 contacting the bore of the associated fluid duct 13 when inserted into it. On the bearing portion 92 there is a annular collar 93 separating two sealed chambers from each other, in which a respective ring seal 94, as for example a seal ring and more particularly an O-ring, is seated. The peripheral face of the annular collar 93 is at a distance from the bore face of the fluid duct 13 so that shifting of the connection sleeve 18 in a radial direction in relation to the longitudinal axis 76 is possible. The provision of two annular seals 94 offers the advantage that the sealing effects are complementary to each other so that even in the case of a positionally caused oblique setting of the union sleeves 18 there is a sealing action in the fluid duct. In order to stop the union sleeve 18 slipping in the axial direction along the longitudinal axis 76 back out of the associated fluid duct 13, there is a locking washer 95 with a through hole, which extends some distance in a radial direction into the fluid duct 13 and accordingly serves as an axial abutment for the annular seals or, respectively, the annular collar 93. In this case as well the outer face of the union sleeve 18 is spaced from the inner bore face of the through hole on the locking washer 95.

The second coupling part 14 has according to a first modification a base portion 47 with the shape of a circular disk corresponding to the first coupling part 12, such portion 47 being surrounded by an attachment portion 48 with the shape of a star, by way of which the second coupling part 14 can be attached to a fluid load, as for example a machine with compressed air loads. In the fluid ducts 15 formed in the second coupling part 14 check valves 20 can be fitted. The cooperation of the union sleeves 18 and the check valves 20 occurs in a fashion identical to that in the first embodiment so that no detailed account thereof is required.

On the two coupling part 14 there are in addition locking pins 51, as for example three in number, which may fit into pin sockets therefor in the first coupling part 12. This serves for relative alignment on slipping the first coupling part over the second coupling part 12 and 14.

The actuating means 23 comprises a setting ring 52, which is mounted on the second coupling part 14 in a rotatable fashion, the setting ring 52 being able to be shifted by a rotary movement about the installation axis 21 as the axis of rotation between a coupling/uncoupling position 26 associated with the ready for use position 24 of the two coupling parts 12 and 14 and a latched position 27 associated with the working position 22 of the two coupling parts 12 and 14.

Unlike the first embodiment of the invention the guide tracks 35 are on the first coupling part 12, namely on its peripheral face 53. The guide tracks 35 are even; distributed over the peripheral face 53, for example with the inclusion of three guide tracks 35. The guide tracks 35 are for their part a part of a groove 36, the bottom groove flank 38 (FIG. 14) serving as a guide track 35.

As guide means in this case there are guide pins 50 evenly distributed over the inner periphery of the setting ring 52, such guide pin projecting from the inner side 54 of the setting ring 52 and accordingly being able to fit into the associated guide track 35 on the first coupling part 12. The guide pins 50 may for example be plugged into the outer face of the setting ring 52 and more particularly be screwed into it. The depth of insertion of a respective guide pin 50 into its respective guide track 35 can be adjusted.

Each respective guide track 35 is divided up into the same portions as has already been explained in conjunction with the first working example. In contradistinction to it however the uphill portion 43 has an arcuate form, for example one similar to a screw slope face.

The FIGS. 25 through 29 show a second modification of the second coupling means 11 of the invention. In this case the setting ring 52 and the first coupling part 12 are coupled together by means of a linking device 81, the latter being so designed that the setting ring 52 and a first coupling part 12 are rotationally coupled together prior to reaching the ready for use position 24 of the first coupling part 12 and are uncoupled from each other in the ready for use position 24 so as to be able to be turned in relation to one another.

The setting ring 52 is of two-part design and possesses an outer ring 96 with an annular shoulder 97 merging with a base portion 98 which on average is smaller. The base portion 98 can be plugged into an annular groove 99 in the second coupling part 14. In contradistinction to the first modification of the second embodiment of the invention the guide pins 50 are located on the outer side of the outer ring 96, whereas the guide tracks 35 are on the outer flank of the annular groove 99. The setting ring 52 furthermore possesses an inner ring 100 connected in a rotationally locked manner with the outer ring 96, for example by means of a press fit. Between the top side of the inner ring 100 and the outer ring 96 there is an annular gap 101, in which there is an annular shoulder 102 of the first coupling parts 12.

As more particularly depicted in FIGS. 26 through 28, the coupling means 81 is located in the inner ring 100. The linking device 81 has several actuating pins 82 and 83 of which respectively a first actuating pin 82 is can move during coupling from an outward travel position, projecting past the bottom side of the setting ring 52 and more particularly of the inner ring 100, owing to contact with the second coupling part 14 into an inward travel position, the first actuating pin 82 being kinematically coupled with a second associated actuating pin 83, which is positively guided by the first actuating pin 82 and corresponding to the outward travel of the first actuating pin 82 between a locking position locking the first coupling part 12 with the setting ring 52 and corresponding to the inward travel position of the first actuating pin 82 corresponding to a release position. The linking bridge 84 is designed in the form of a pivotal lever 87, which with a pivot axis 88 and at one end it is pivoted on the first actuating pin 82 and at the other end is pivoted on the second actuating pin 83.

As more particularly illustrated in FIG. 28 the actuating pins 82 and 83 are respectively guided in a guide channel 103 and 104, which is axial in relation to the installation axis 21 in the inner ring 100 of the setting ring 52. In the portion between the two guide channels 103 and 104 the pivotal lever 87 is pivoted, i.e. for example as illustrated in FIG. 28 the middle portion 106 of the pivotal lever 87 is cylindrical in shape and mounted for pivoting in a bearing socket 105 which is complementary and is cylindrical in configuration. The pivotal arms 107 and 108 projecting from the middle portion 106 of the pivotal lever 87 have at their respective ends a convexly formed projection 109 which pivots in a mutually corresponding bearing eye 110 in the associated actuating pin 82 and 83.

One of the actuating pins 82 extends in its outward travel position past the bottom side of the inner ring 100, whereas the other actuating pin 83 extends, in its locking position, past the top side of the inner ring 100 and fits into a locking opening in the annular shoulder 102 of the first coupling part 12 so that the first coupling part 12 and the inner ring 100 are rotationally locked together. It is possible to provide several such pairs distributed over the periphery of the outer ring 96 and, respectively, of the inner ring 100 on actuating pins 82 and 83. Furthermore a spring 111 is present, which is located in the guide channel of the second actuating pin 83 and which bears at one end against a pin 112 mounted in the guide channel 104 and is more particularly in the form of a threaded pin and at the other end thrusts the second actuating pin 83 by spring force into its locking position.

The coupling operation according to the first modification of the invention is depicted in FIGS. 14 through 16. In accordance with FIG. 14 the two coupling parts 12 and 14 are firstly in their working position 42, the two mutually opposite joint faces 17 and 19 being in mutual contact with each other. The setting ring 52 is located in its latched position 27 and the guide pins 50 are in the respective holding position 44 of the guide track 35 assigned to them. Now the setting ring 52 is turned clockwise, the guide pins 50 sliding along the uphill portions 43 until they finally snap into the respective latching notches 60 in the securing portion 41. This position characterizes the captive position 80 (FIG. 15) of the two coupling parts 12 and 14 so that as already explained above proper venting is ensured. On further rotation of the setting ring 52 clockwise the guide pins 50 spring out of their latching notches 60 to then reach the respective coupling/uncoupling section 40 of the respective guide track 35. On this portion there is in the first coupling part 12 again a respective opening to the bottom side or respectively the joint face 17 so that the first coupling part 12 can be “threaded on” and removed from the second coupling part 14.

The coupling operation takes place in the reverse manner, the coupling force required for coupling being provided by manual rotation of the setting ring 52.

During coupling in accordance with the second modification of the invention the first coupling part 12 and the setting ring 52 are rotationally locked with each other via the linking means 81. In this case the first actuating pin 82 projects proud of the bottom side of the inner ring 100, whereas the second actuating pin 83 fits into the locking opening in the first coupling part 12. Locking together of the first coupling part 12 and the setting ring 52 allows accurate positioning and alignment of the fluid ducts 13 in the first coupling part 12 in relation to the fluid ducts 15 in the second coupling part 14. When the desired position has been found and when each fluid duct 13 in the first coupling part 12 has its corresponding partner on the second coupling part 14, the unit consisting of the first coupling part 12 and the setting ring 52 is slipped over the second coupling part 14, the base portion 98 of the setting ring 52 then fitting into the annular groove 99 in the second coupling part 14. Then the end, which stands proud of the bottom side of the outer ring 96, of the first actuating pin 82 touches the floor of the annular groove 99 so that the actuating pin 82 is thrust upwardly. The actuating pin 72 is accordingly shifted upwardly in the guide channel 103 so that owing to the linking of the actuating pin 82 with the pivotal lever 87 the latter is rotated clockwise. Then the pivotal arm 108, associated with the second actuating pin 83, of the pivotal lever 87 thrusts the second actuating pin 83 against force of the spring 11 downward so that the second actuating pin 83 is shifted out of the locking opening in the first coupling part 12. Accordingly the setting ring 52 and the first coupling part 12 are unlocked. After this the setting ring 52 can be turned in relation to the first coupling part 12, the guide pins 50 sliding along the guide track or cam 35 on the second coupling part 14 so that the first coupling part 12 is shifted from its ready for use position 23 into the working position 22. The uncoupling from the setting ring 52 and the first coupling part 12 offers the advantage that on rotation of the setting ring 52 the first coupling part 12 and accordingly any flexible fluid lines connected thereon does not have to be turned therewith. This serves to prevent any twisting of the flexible fluid lines and accordingly any opposing force acting against the direction of rotation.

FIGS. 17 through 24 finally show a third embodiment of the coupling means 11 in accordance with the invention. A first coupling part 12 is provided, which is like a rectangular box and surrounds the second coupling part 14 in the form of a rectangular block. That is to say the first coupling part 12 can be slipped over the second coupling part 14. On the first coupling part 12 there are first fluid ports, arranged in a grid pattern like the above described working examples, in the form of fluid ducts 13, into which union sleeves 18 are inserted. The same correspond to second fluid ports in the second coupling part 14, which are also in the form of fluid ducts 15 and are integrated in the check valves 20.

The actuating means 28 possesses a handle in the form of a yoke 55, which may be pivoted around a pivot axis, extending essentially perpendicularly to the installation axis 21, between a coupling/uncoupling position 26 associated with the ready for use position 24 of the two coupling parts 12 and 14 and a latched position 27 associated with the working position 22 of the two coupling parts 12 and 14. The yoke-like handle 55 possesses a pivot axle body 57, which is mounted for pivoting in the second coupling part 14 and is inserted through a through opening so that it projects on either side of the second coupling part 14.

As more particularly illustrated in FIG. 20 on either side of the second coupling part 14 at the projecting portions of the pivotal axle body 57 there are setting disks 58, which are mounted for linear movement on the pivotal axle body 57. As shown in FIGS. 21 through 23, the setting disks 58 have the shape of a circular segment.

On the outer side of each setting ring 58 there is a guide track in the form of a guide cam 35, into which a guide pin 50 (extending in an inward direction and projecting from the inner side coupling part 12) may fit. The setting disks 58 are as already mentioned able to slide on the pivotal axle body 57, and in each case on pivoting of the handle-like yoke 55 they slide between a released position permitting the guidance of the guide pin on the associated guide cam 35 or track and a locking position locking the guidance of the guide pin. The setting disks 58 are held by means of spring means, more particularly compression springs 75, on the screw body 57, in their locked position. Each respective compression spring 75 bears in this case at one end on the second coupling part 14 and thrusts the setting disk 58 assigned to it outward so that the respective guide pin 50 on the first coupling part 12 snaps into a latching socket 63 provided therefor so that it is prevented from sliding on the associated guide cam 35. The handle-like yoke 55 may consequently not be pivoted.

The handle-like yoke 55 furthermore possesses an outer portion 64, which is connected in a manner preventing relative rotation with the pivotal axle body 57. The outer portion 64 may have a more particularly semicylindrical transverse bar 65 and longitudinal bars 66 like round rods projecting essentially perpendicularly from the same. On the longitudinal bars there are respectively in each case a bearing disk 85 (FIG. 19), which is rotationally locked with the pivotal body 57. There is furthermore an inner part 67 mounted in an adjustable fashion on the outer part 64, which serves to shift the setting disks 58 against the force of the compression springs 75 into the released position. The inner part 67 possesses an also semicylindrical transverse bar 68, which can constitute a complete fully cylindrical readily gripped transverse bar, with the transverse bar 65 of the outer part 64. At the two ends of the transverse bar 68 two band-like longitudinal bars 69 are attached, which for their part in each case, attached at their outer sides, possess a guide body 70 with a through opening 64 for the associated longitudinal bar 66 of the outer part 64. At the end remote from the transverse bar 68 of each longitudinal bar 69 a slot 71 is provided, by way of which the longitudinal bar 69 may be slipped onto the pivotal axle body 57. As more particularly depicted in FIGS. 18, 20 and 23 the front end of each longitudinal bar 69 is shaped like a wedge, i.e. the longitudinal bar 69 widens out toward the front end.

The uncoupling operation is represented in FIGS. 21 through 24. The handle-like yoke 55 is located initially in its top position, i.e. in a latching position 27 thereof, the two coupling parts 12 and 14 having their joint faces 17 and 19 in engagement with each other. The guide pins 50 on the first coupling part 12 are located in the holding portion 44, that is to say in the latching socket 63. The guide pin 50 is spaced at a radius R₁ from the pivot axis 56. The two transverse bars 65 and 68 are spaced from the outer part and the inner part 64 and 67 respectively, the wedges 72 at the end of the longitudinal bars 69 being out of engagement with the setting disks 58.

Now the inner part 67 is drawn toward the outer part 64 by thrusting the two transverse bars 65 and 68 together. Then the inner part 67 is shifted toward the outer part 64, something which means that the two wedges 72 are thrust against the setting disks 58 on the pivotal axle body 57. In this case the setting disks 58 are thrust inward by the force of the compression spring 75 so that the guide pins 50 are sapped out of their latching sockets 63 and it is possible for the same to slide on the respectively associated guide cam 35. Each respective guide pin 15 then runs along a short uphill portion to arrive at the securing portion 41, where it ing s into the latch notch 60 provided for this. This position characterizes the captive position 80 of the two coupling parts 12 and 14 so that proper venting is possible. If the handle-like yoke 55 is now shifted on still farther downward the guide pins 50 will go along a further uphill portion 43 at the coupling/uncoupling section 55 of the guide cam 35. At this position each guide pin 50 is spaced from the pivot axis by the radius R₂. Here the relationship R₂>R₁ applies. In the coupling/uncoupling position 26 of the handle-like yoke 55 the two coupling parts 12 and 14 are in their ready for use position 24, in which the two oppositely placed joint faces 17 and 19 are spaced apart. The guide pin 50 may now be “unthreaded” by way of a respective opening, which is on the narrow side of the setting disk 58.

The coupling operation takes place in the reverse order, the coupling force for coupling the two coupling parts 12 and 14 being applied manually by rocking the handle-like yoke 55.

1. A multiple coupling means for the production of a releasable connection between fluid lines for a fluid pressure medium and associated with a fluid pressure source, said lines being on the source side and fluid lines associated with at least one fluid load and placed on the load side, said coupling means comprising a first coupling part having several first fluid ports for the fluid lines on the source side and a second coupling part possessing several second fluid ports for the fluid lines on the load side, the two coupling parts being able to be shifted in a coupling operation into a working position by being moved together in the direction of an installation axis, in which working position mutually opposite joint faces engage each other and in which the two coupling parts are secured by means of holding means to avoid accidental uncoupling, wherein an actuating means able to be operated manually is provided, by means of which the coupling parts are able to be shifted from a ready for use position, in which the coupling parts are releasably in contact with each other and the joint faces are spaced apart, using force transmission means into the working position.

2. The coupling means in accordance with claim 1, wherein, between the ready for use position and the working position, a captive position is provided in which the mutually opposite joint faces are spaced apart and the coupling parts are joined together undetachably.

3. The coupling means in accordance with claim 1, wherein the force transmission means comprise at least one guide track, on which the at least one guide element is positively guided on operation of the actuating means, and the guide track has such a course of the track that the coupling parts on coupling can be shifted toward each other and on uncoupling away from each other.

4. The coupling means in accordance with claim 3, wherein the guide track/has a coupling/uncoupling section associated with a ready for use position of the coupling parts, and in such section the guide element for the purpose of a coupling operation may be brought into contact with the associated guide track or for uncoupling out of contact with the associated guide track, the guide track possesses an associated holding portion associated with working position of the coupling parts and in such holding portion the guide element secures the two coupling parts to avoid automatic uncoupling between the coupling/uncoupling section and the holding portion.

5. The coupling means in accordance with claim 4, further comprising a securing portion between the coupling/uncoupling section and the holding portion, said securing portion being associated with the captive position of the two coupling parts and in such securing portion the guide element may be so positioned that the two coupling parts are secured in relation to each other when the joint faces are separated from one another.

6. The coupling means in accordance with claim 2 wherein a the guide track is a component of a groove-like guide slide.

7. The coupling means in accordance with claim 1, wherein in the first fluid connections of the first coupling part at least one union member, in the form of a sleeve, is integrated for the connection of at least one fluid line on the source side, and in the second fluid union of the second coupling part at least one check closure member, is integrated, the check closure member being able to be opened on coupling the two coupling parts by means of the union members and may be held in the open position.

8. The coupling means in accordance with claim 7, wherein the union members are mounted in a floating manner radially in relation to their respective longitudinal axis in the fluid ports.

9. The coupling means in accordance with claim 1, wherein the actuating means is so designed that it can be shifted in a linear movement athwart the installation axis between a coupling/uncoupling position corresponding to the ready for use position of the two coupling parts and a latched position corresponding to the working position of the two coupling parts.

10. The coupling means in accordance with claim 9, wherein the actuating means possesses an actuating yoke mounted in a sliding manner in the second coupling part for motion between the coupling/uncoupling position and the latched position.

11. The coupling means in accordance with claim 10, wherein the actuating yoke possesses a base portion and two limbs extending essentially perpendicularly from the base portion, the limbs being guided in respectively associated guide sockets in the second coupling part.

12. The coupling means in accordance with claim 11, wherein on each on the limbs and more especially on the at least one guide track is provided for guiding respectively at least one guide element, formed on the first coupling part, in the form of a guide pin.

13. The coupling means in accordance with claim 1 wherein the actuating means is so designed that it can be rotated in a rotary movement with the installation axis as an axis of rotation between a coupling/uncoupling position corresponding to the ready for use position of the two coupling parts and a latched position, corresponding to the working position of the two coupling parts.

14. The coupling means in accordance with claim 13, wherein the actuating means comprises a setting ring that is mounted in a rotatable fashion on the second coupling part and on rotation shifts the first coupling part by cooperation of the guide track and the guide means from the ready for use position into the working position and vice versa.

15. The coupling means in accordance with claim 14, wherein the setting ring and the first coupling part are linked together by means of a linking device, such that the setting ring and the first coupling part are linked together on coupling prior to reaching the ready for use position of the first coupling part in a rotationally locked manner and in the ready for use position they are uncoupled from each other so that they may be turned in relation to each other.

16. The coupling means in accordance with claim 15, wherein the coupling means comprises several actuating pins of which in each case a first actuating pin may be shifted from an outward travel position extending past the bottom side of the setting ring during coupling by contact with the second coupling part into an inward travel position, the first actuating pin being kinematically by way of a linking bridge with an associated actuating pin, said pin being able to be shifted for its part in a manner corresponding to the outward travel position of the first actuating pin between a locking position locking the first coupling part with the setting ring and, corresponding to the inward travel position of the first actuating pin, a release position.

17. The coupling means in accordance with claim 16, wherein the linking bridge is designed in the form of a pivoting lever, pivoting at a pivot axis which is at one end is mounted in a pivoting manner on the first actuating pin and at the other end is mounted in a pivoting manner on the second actuating pin.

18. The coupling means in accordance with claim 14 wherein on the inner side or on the outer side of the setting ring, outer periphery, guide elements in the form of guide pins are provided, which are guided in guide tracks formed on the first coupling part or in the second coupling part.

19. The coupling means in accordance with claim 1, wherein the actuating means is so designed that it can be pivoted in a pivoting movement about a pivot axis running essentially perpendicularly to the installation axis between a coupling/uncoupling position associated with the ready for use position of the two coupling parts and a latched position associated with the working position of the two coupling parts.

20. The coupling means in accordance with claim 19, wherein the actuating means comprises a handle-like yoke with a pivotal axle body mounted pivotally in the second coupling part, on which at least one setting disk is arranged for linear sliding motion, the setting disk being able to move on pivoting of the handle-like yoke between a released position permitting the guidance of the guide element on the associated guide track and a locked position locking guidance of the guide element.

21. The coupling means in accordance with claim 20, wherein on the setting disks, a guide track in the form of a guide cam and on the first coupling part a guide element in the form of a guide pin able to be guided along the guide cam are provided.

22. The coupling means in accordance with claim 20, wherein the setting disk is loaded by spring means, mounted on the pivotal axle body, toward the locking position.

23. The coupling means in accordance with claim 19, wherein, in the locking position of the setting disks, the guide pin is snapped into a latching socket, preventing sliding of the guide pin on the associated guide cam.

24. The coupling means in accordance with claim 20, wherein the setting disk possesses a circular segment-like configuration.

25. The coupling means in accordance with claim 22, wherein the handle-like yoke has an outer part and an inner part mounted in an adjustable fashion on the outer part for the adjustment of the setting disk against the spring force of the spring means into the released position.
